(19) United States
(12) Patent Application Publication
(10) Pub. No.: US 2015/0223437 A1
(43) Pub. Date: Aug. 13, 2015

(54) FISHING LURE

(71) Applicant: Freedom Tackle Corp., Weston (CA)

(72) Inventor: Michael Tamburro, Weston (CA)

(73) Assignee: Freedom Tackle Corp., Weston (CA)

(21) Appl. No.: 14/617,169

(22) Filed: Feb. 9, 2015

(30) Foreign Application Priority Data
Feb. 7, 2014 (CA) 2842197

(51) Int. Cl. A01K 85/14; A01K 91/04; A01K 85/00

(52) U.S. Cl. CPC A01K 85/14; A01K 85/00; A01K 91/04

(57) ABSTRACT

The present invention relates to a fishing lure having a wire shaft that passes thru the middle section of the lure body through an aperture. The aperture is preferably located between the center of the lure and the front edge of the lure. The shaft has a fishing line tie means at its top end, at least one free sliding bead above the lure body, at least one free sliding bead underneath the lure body, and hook attachment means on the bottom end of the shaft for replaceable attachment of one or more hooks.

### TECHNICAL FIELD

The present disclosure relates to fishing lures, specifically those that mimic the erratic action of a slowly dying baitfish.

### BACKGROUND

A fishing lure is an object attached to the end of a fishing line which is designed to resemble and move like the prey of a fish. The purpose of the lure is to use movement, vibration, and colour to catch the fish's attention so it bites the hook. Lures are equipped with one or more single, double, or treble hooks that are used to hook fish when they attack the lure. Fishing lures differ in size, weight, shape, composition, design, and function and may include mechanisms to produce noise or vibrations.

One type of a fishing lure is a fishing spoon. A spoon is an oblong, usually concave lure, similar to the bowl of the ordinary eating spoon. Spoons are commonly designed to create movements through water that suggest or mimic the movements of a baitfish or a slowly dying baitfish. The curvatures of the spoon, allows it to flutter or wobble when fished in the water column.

In the conventional art, lures have a line tie at the front and a single or treble hook attached at the rear via a wire split ring. Some lures have sound chambers or other mechanisms such as beads, which create sound vibrations when the lure comes to a rest position at the end of the angler's fishing line. It is believed that sound vibrations aid in attracting fish.

In the conventional art, lures drop quickly in the water and seldom stay below the angler when dropped because its fluttering action causes the lure to drift away from the angler. After the lure's descent, the line tie of the lure is at the top of the vertical rest position (closest to the angler) and the hook is at the bottom of the lure. When a lure falls away from the angler, the angler cannot detect the lure's relation to the bottom with a commonly used fish finder; because the lure has moved out of the fish finders' transducer's cone. The angler will not know how deep the lure is or whether a fish is tracking the lure for a strike. The angler also will have a slack line when the lure drifts to the side resulting in less feel when a fish hits and a diminished hook set when a fish hits the lure.

### SUMMARY

In one embodiment, the disclosure comprises a fishing lure with a body having a front section, a rear section and a middle section therebetween. An aperture is provided in the middle section for receiving a shaft therethrough. The shaft has fishing line tie means at one end and hook attachment means at the opposite end. The aperture is sized so that the lure body can move up towards the line tie means or down towards said hook attachment means on said shaft.

### BRIEF DESCRIPTION OF THE DRAWINGS

The present invention may be further understood by reference to the description of the embodiments, taken in conjunction with the accompanying drawings, in which:

FIG. 1 is a side perspective view that shows one embodiment of a lure of the present invention.

FIG. 2 is a top perspective view of the lure shown in FIG. 1.

FIG. 3 is a rear end view of the lure shown in FIG. 1.

FIG. 4 is a front end view of the lure shown in FIG. 1.

### DETAILED DESCRIPTION

The description, which follows, and the embodiments described therein are provided by way of illustration of an example, or examples of particular embodiments of principles and aspects of the present invention. These examples are provided for the purposes of explanation, and not of limitation, of those principles and of the invention. In the description that follows, like parts are marked throughout the specification and the drawings with the same respective reference numerals.

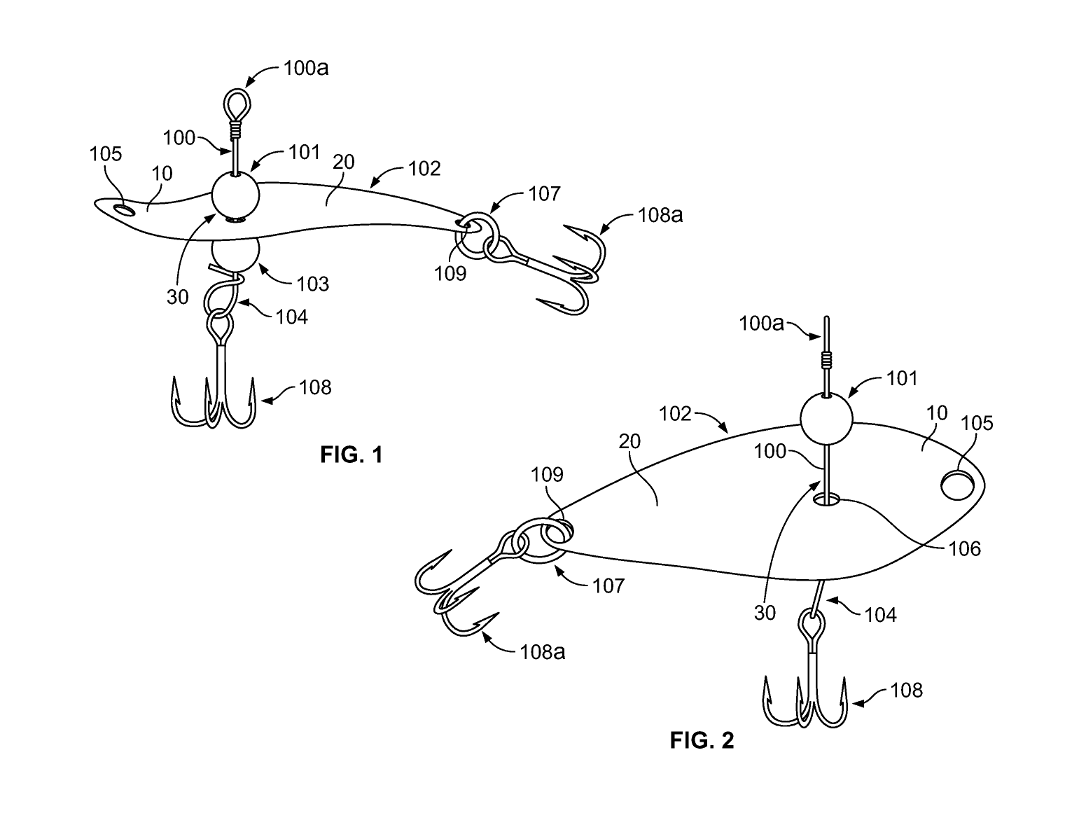

FIGS. 1 to 4 show an embodiment of a fishing lure. The lure shown has a fish shaped body 102 but any body shape that appears to be food to a fish whether it is made of metal, plastic, resin, or wood. Body 102 has a wire shaft 100 passing through the body 102 through an aperture or hole 106 on the longitudinal axis of body 102. Although hole 106 in the embodiment shown is located between the center of the lure and the front edge of the lure, hole 106 may be located on the longitudinal axis of body 102 ranging from a distance of 15% of the total length of body 102 from the front edge to a distance of 15% of the total length of body 102 from the back edge. The determination of the location of hole 106 depends on the desired lure movement. For example, the closer hole 106 is to the center of body 102 the more horizontal the lure will be at rest. A hole position on the longitudinal axis that appears to give the lure the best action is at approximately one third the total length of body 102 as measured from the front edge towards the rear of the lure.

In the embodiment shown, shaft 100 has a fishing line tie means 100a at the top, at least one free sliding bead 101 above the body 102, at least one free sliding bead 103 underneath the body 102, and hook attachment means 104 on the end of the shaft for replaceable attachment of one or more hooks 108. Hook 108 may be of different sizes and shapes to accommodate the fisherman's preferences.

Although hook attachment means 104 is shown as a wire having a line tying section and a twist section, such as described in PCT/CA20 12/000959, other known hook attachment means such as a wire split ring may also be used. The number, composition and location of beads 101 and 103 with respect to the lure may vary as long as sound vibration is created when the lure starts and ends its motion. In one aspect, bead 101 may be made of hollow or solid metal and bead 103 may be made of hollow or solid glass. Hole 106 for shaft 100 is optionally dimensioned such that shaft 100 will collapse parallel to the body 102 when a fish strikes. The collapse of shaft 100 provides a more efficient hook set and creates less stress on shaft 100, which minimizes bending or breaking of shaft 100 when a fish is hooked.

As shown in FIGS. 1 and 4, the body 102 has a front section 10, rear section 20, and a middle section 30. Hole 106 is situated in middle section 30. The middle section 30 has longitudinally side edges 40 curved upwards to give a concave cross section. Body 102 has an upward bent front section 10 with an optional second aperture or hole 105 situate near the front edge of the front section 10. Hole 105 allows the lure to travel forward when the lure is pulled upward. An upward bent configuration of the front section 10 of the lure with hole 105 exhibits more upward erratic movement than a straight or downward bent front section 10 with hole 105. However, a lure having a straight or downward bent front section 10 will also function in accordance with the objectives of this invention.

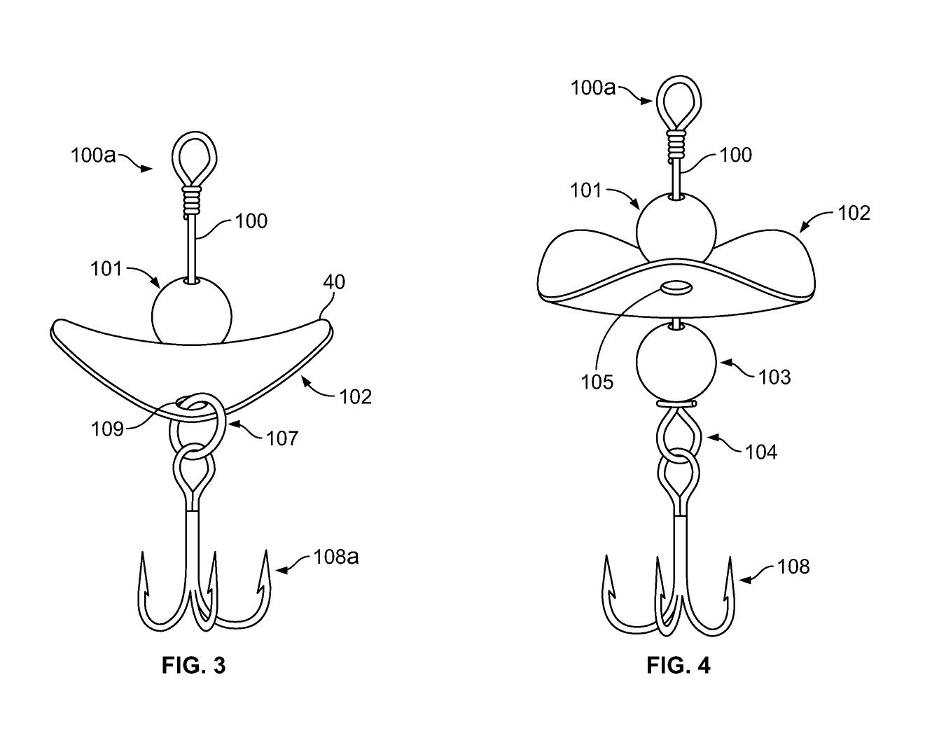

As shown in FIGS. 1 and 3, rear section 20 of body 102 has a downward bend starting rearward of hole 106 and continuing towards the rear edge of the lure. The surface of back section 20 may optionally be straight provided the outer edges 40 of the lure are curved which assists in creating a fluttering action of the lure. The downward curvature of rear section 20 prevents the treble hook 108 from hooking up on the lure.

As shown in FIG. 3, the rear section 20 of the lure may have an aperture or hole 109 with hook attachment means, such as a split ring 107, for replaceable attachment of one or more hooks 108a. The rear section 20 may be straight or curved upwardly but such configurations do not prevent the hook from tangling with the lure body.

The shape of the lure body 102 may be comprised of optional body shapes to give the bait a different appearance; any shape that mimics the fish's forage may be used. In each embodiment, body 102 has a through shaft construction assembly, causing the lure to flutter slowly, horizontally and erratically directly beneath the angler. The lure may optionally have beads 101 and 103 (metal or glass) on shaft 100 to create or enhance sound vibrations. Lure shapes may range from generally elliptical to rectangular, with the lure length greater than the width.

In operation, the lure slowly flutters erratically to and fro and side to side leaving the lure in the strike zone longer. The shaft positioned through the body of the lure permits a horizontal drop so that the lure remains below the angler throughout the fall and at rest. Free sliding hollow or solid metal and glass beads on the shaft add the ability to create sound vibrations with the shaft on the lift and the drop. The shaft has a line tie which eliminates the need to tie the line on the front end of the lure. A replaceable hook is attachable at the end of the shaft under the lure body.

Although the above description and accompanying drawings relate to preferred or exemplified embodiments of the present invention; the scope of the claims should not be limited by the preferred or exemplified embodiments, but should be given the broadest interpretation consistent with the description as a whole.

What is claimed is:

1. A fishing lure comprising:
a. a lure body having a front section, a rear section and a middle section therebetween;
b. an aperture in the middle section for receiving a shaft therethrough,
c. the shaft having line tie means at one end and hook attachment means at the opposite end;
d. and wherein the aperture is sized to permit the lure body to move up towards the line tie means or down towards said hook attachment means on said shaft.

2. A lure of claim 1, wherein the front section has an upward bend.

3. A lure of claim 1, wherein the rear section has a downward bend.

4. A lure of claim 3, wherein the middle section comprises longitudinally side edges curved upwards to form a generally concave top surface.

5. A lure of claim 1, wherein the aperture is situate along the longitudinal axis of the body at a distance between 15% of the total length of the body from the edge of the front section and 15% of the total length of the body from the edge of the back section.

6. A lure of claim 5 wherein the aperture is situate at one third the total length of body as measured from the edge of the front section towards the edge of the rear section.

7. A lure of claim 5, further comprising a second aperture situate proximate the edge of the front section.

8. A lure of claim 7, further comprising at least one free sliding bead on the shaft adjacent the top surface of the body and at least one free sliding bead on the shaft adjacent the bottom surface of the body.

9. A lure of claim 8 wherein the bead adjacent the top surface is metal and the bead adjacent the bottom surface is glass.

10. A lure of claim 1 wherein the aperture for the shaft is dimensioned such that the shaft will collapse parallel to the lure body when a fish strikes.

11. A lure of claim 1 wherein the lure body is in the form of a fishing spoon.
